(19) United States
(12) Patent Application Publication
(10) Pub. No.: US 2026/0059284 A1
(43) Pub. Date: Feb. 26, 2026

(54) Emergency Alert System

(71) Applicant: Nova Soft LLC, Avon, OH (US)

(72) Inventors: Tim Vala, Avon, OH (US); Kurtis Burns, Lakewood, OH (US)

(21) Appl. No.: 18/812,647

(22) Filed: Aug. 22, 2024

(51) Int. Cl. H04W 4/90; G08B 27/00; H04W 4/029

(52) U.S. Cl. CPC H04W 4/90; G08B 27/00; H04W 4/029

(57) ABSTRACT

An emergency alert system and method for providing proximity-based alerts in real-time is provided. The system generates a virtual perimeter around one or more entities, wherein real-time location information is used to determine whether a first entity is within the virtual perimeter generated around a second entity, and wherein the system will send an alert once the first entity enters the perimeter and terminate the alert once the first entity exits the perimeter. The system may the rate of data transmission depending on whether the first entity is registered in a database corresponding to a geographical region where the system is administered and whether the second device is in an active broadcasting mode. The system also predicts the location of the first and second entities and uses the difference between the predicted location and actual location to adjust the location and size of the perimeter to provide adequate warning.

### FIELD OF INVENTION

This invention relates to a system and methods for generating and communicating emergency alerts and notifications between communications devices moving relative to each other.

### BACKGROUND INFORMATION

Despite the sirens and flashing lights, there may be numerous reasons that an operator of a motor vehicle may not be aware of an approaching emergency vehicle. Some vehicles are manufactured to dampen or reduce exterior noise to a degree that it may be difficult to hear distant sirens. A driver may be playing audio with the volume too loud to hear sirens. A driver may be distracted by media playing in the vehicle, by eating, or by other passengers in the vehicle and may not notice distant flashing lights, increasing the chances the driver may collide with the emergency vehicle or otherwise create an unsafe situation. Additionally, inattentive drivers may cause delays for emergency vehicles by blocking lanes and faster traffic routes, which could delay life-saving treatment to others.

Moreover, vehicles may travel very quickly on roadways, especially in emergency situations where time is of the essence. However, the faster two vehicles are moving, the sooner they will meet, meaning that the time for a driver to react is shorter. In particular, when an emergency vehicle is approaching a driver from opposite directions, the speeds add together. For example, an emergency vehicle traveling at 70 mph toward a civilian vehicle traveling 80 mph would be the equivalent of the civilian vehicle moving toward a stationary object at 150 mph. With such high speeds, an early warning system is needed to alert distracted drivers of a potential and fast-approaching hazard.

One particular challenge in generating and providing alerts based on the locations of two entities is to accurately provide updated location data in real-time, especially when one or both entities is moving at a high speed. As the relative speed between two entities increases, the warning time is dramatically shortened, and the distance traveled between location “pings” is greater, leading to greater uncertainty about the current, real-time position of the entities as a result of more granular data.

Another challenge in providing such alerts is managing power and data resources in the system. The faster the entities in the system send and receive data, the more accurate the predictions and thus the warnings will be. However, this also increases power consumption by the devices sending and receiving data, and burdens computational resources of the entities and the overall system.

Some methods of P2P (peer-to-peer) and V2X (vehicle-to-everything) communications are known, including in the context of proving alerts to moving vehicles. However, these methods fail to overcome the problems in the field mentioned above. Thus, a solution is needed for providing and handling real-time location data, verifying the accuracy of their predictions, updating alert criteria based on accuracy and user settings, balancing power consumption and data resources, and pre-empting the function of non-essential software and media.

### SUMMARY

The following is a summary of the various aspects of the invention. This summary is not an extensive overview of all embodiments within the scope of the invention and instead merely presents some concepts to illustrate the invention as an introduction to the detailed description below.

The present invention seeks to improve upon the prior art by providing a system that predicts the position of entities based on current and historical location data, verifies the accuracy of its predictions based on updated location data, adjusts criteria for triggering an alert based on the differences between the predicted and actual location data, and/or provides an alert that pauses non-essential software and media while the emergency event is ongoing.

In one aspect, the invention is a system for generating proximity-based alerts in real-time. The system includes a computer-implemented software or application installed on a computer server, a first software installed on a first device, and a second software installed on a second device wherein the first and second devices and computer server are in communication with each other via a communications network. The computer-implemented software receives location data from the first device and second device and generates a virtual perimeter around the second device based on the location of the second device and having an initial radius. The computer-implemented software determines whether the location data associated with the first device overlaps any point within the perimeter. Once it does, the computer-implemented software generates a first signal causing the first device to perform an alert while the location of the first device remains within the perimeter. The computer-implemented software continuously receives new location data from the first and second device and continuously generates new perimeters based on at least the location of the second device. Once the computer-implemented software determines that the location of the first device is no longer overlapping any point within the perimeter, the computer-implemented software generates a second signal causing the first device to perform an exit alert.

In some embodiments, the computer-implemented software predicts the movement of the first device and/or the second device based on one or more of current location, historical location, data transmission rates, speed, and movement vectors. The computer-implemented software verifies the accuracy of predicted movements based on actual location data received, and it uses the differences between the predicted and actual locations to adjust the location and/or radius of the perimeter.

In other embodiments, the system further includes a region defined by a boundary, wherein the computer-implemented software will only generate perimeters once the first device and second device are registered in a database corresponding to the region. In some aspects of this embodiment, the first device may have a passive low-frequency mode while it is located outside the region, wherein location data is transmitted at a low frequency to the computer-implemented software to determine whether the first device is within a registered region, and an active low-frequency mode while it is located inside the region, wherein location data of the first device is transmitted at a at a low frequency to the computer-implemented software to determine whether any second device within the region is actively broadcasting its location data. In further aspects, the first device may have an active high frequency mode once both the first and second devices are within the region and the second device is actively broadcasting its location data, wherein location data of the first device is transmitted at a at a higher frequency to the computer-implemented software to determine whether the location of the first device overlaps any point within the perimeter.

In other embodiments, the alert causes the first device to mute any visual or audio media playing on the first device and to disable programs and applications on the first device from providing haptic feedback to eliminate distractions. In these embodiments, the exit alert causes the first device to resume any visual or audio media that was previously paused and to re-enable programs and applications to provide haptic feedback. In some variants, the alert also causes the first device to pause the function of any non-essential software (i.e. software that is not necessary for the first device to carry out the functions described herein) running on the first device. In these variants, the exit alert causes the first device to resume any non-essential software that was previously paused due to the alert.

In another aspect, the condition for triggering an exit alert is an event other than the first device exiting a perimeter, including the location of the first device arriving at some predetermined location or area, or the computer-implemented software detecting no change in the location of the first device over a pre-determined period of time.

In another aspect, the invention is a method for generating proximity-based alerts in real-time. The method involves obtaining the initial locations of first and second devices, determining whether the location of the first device overlaps a region defined by a boundary. If not, the process restarts. If so, the method obtains information about the broadcasting mode of the second device and determines whether the second device is in a broadcasting mode. If not, the process restarts. If so, the method generates an initial perimeter having a first radius and being based at least in part on the location of the second device and determines whether the location of the first device is within the perimeter. If so, the method sends a first signal to the first device. The method then obtains new location data from the first and second devices and generates a new perimeter. The method next determines whether the new location of the first device overlaps any point within the new perimeter. If so, the method will send the first signal to the first device if it has not already done so and returns to obtaining new location data from the first and second devices. The method continues to repeat these steps until it determines that the new location of the first device no longer overlaps any point within the new perimeter, at which point it generates and sends a second signal to the first device.

### BRIEF DESCRIPTION OF THE DRAWINGS

FIG. 1 is an exemplary overview of the physical components of the system according to a first embodiment of the invention.

FIGS. 2A-2G is an exemplary overview of the system showing sequentially how alerts are generated according to the first embodiment of the invention.

FIG. 3 is a diagram showing the process for using a publisher application in accordance with the first embodiment of the invention.

FIG. 4 is a diagram showing the process for using a user application according to the first embodiment of the invention.

FIG. 5 is a diagram showing the process for performing an alert according to the first embodiment of the invention.

FIG. 6 is a diagram showing the process for performing an exit alert according to the first embodiment of the invention.

FIG. 7 is a diagram showing the process for generating, checking for overlaps, and updating, the publisher perimeter and for generating and sending alert signals and exit alert signals according to the first embodiment of the invention.

FIGS. 8A-8C show examples of visual, audio, and haptic alerts performed on a user device according to a second embodiment of the invention.

FIGS. 9A-9C show examples of visual, audio, and haptic exit alerts performed on a user device according to a second embodiment of the invention.

FIG. 10 is an exemplary overview of the system showing an environment with a plurality of user devices and a plurality of publisher devices according to a third embodiment of the invention.

FIGS. 11A-11D is an exemplary overview of the system showing sequentially how alerts are generated according to a fourth embodiment of the invention.

FIGS. 12A-12E is an exemplary overview of the system showing sequentially how alerts are generated according to a fifth embodiment of the invention.

FIG. 13 is an exemplary overview of the system showing an environment with a plurality of publishing regions according to a sixth embodiment of the invention.

FIG. 14 shows an example of a setting screen on a publisher device according to a seventh embodiment of the invention.

FIGS. 15A-15B show examples of a publishing mode switch on a publisher device according to an eighth embodiment of the invention.

FIG. 16 is an exemplary overview of the inside of a vehicle housing a publisher device and a separate switch according to a ninth embodiment of the invention.

### DETAILED DESCRIPTION

The following detailed description makes reference to the accompanying drawings, which show by way of example various embodiments of aspects of the invention. The same reference numbers may be used in different drawings to identity the same or similar elements. However, while like numbers may represent similar elements across different embodiment, they do not necessarily refer to the same or similar elements. Specific details are set forth in the description below pertaining to particular structures, architecture, interfaces, technologies, etc. to provide a clear understanding of the invention. However, the invention is not limited to those particular identified items, and it will be apparent to a person having ordinary skill in the art that some aspects of the invention may differ from those specific details and some elements may be modified without departing from the scope of the invention. Additionally, while various methods may be presented as a series of steps in a particular order, such presentation should not be construed to imply that all steps must be present and in the same order, and a person having ordinary skill in the art will recognize that some steps may be omitted, repeated, altered, or reordered without departing from the scope of invention. Furthermore, even though particular combinations of features are recited in the claims and/or disclosed in the specification and drawings, such particular combinations are not to be construed as limiting the disclosures of those embodiments, and many of the features may be combined in ways that are not specifically recited without departing from the scope of the invention. Moreover, while some features are described as being carried out on one or another computing device, it should be understood that such features may be shifted from one computing device to the other or separated and carried out on additional computing devices, including separately or in parallel without departing from the scope of the invention.

The general concept of the present invention is to provide a system and software environment wherein a subscribing user will receive warning notifications that will cause the user device to interrupt other software and media to display a visual, auditory, or haptic alert when the user approaches and enters a mobile publisher perimeter established around a publisher device. Upon occurrence of a triggering event, such as the user device exiting the publisher perimeter, the user device is able to resume any interrupted software or media. In some senses, the invention can be described as a “digital siren”.

By way of a non-limiting example, one intended application of the invention is to warn drivers of rapidly approaching emergency vehicles. In this example, the system generally comprises a software application installed on a user's device, a software application installed on an emergency responder's (publisher's) device or installed on equipment in an emergency vehicle, and cloud-based software and databases for authenticating device identifiers, permitting transmission and receipt of messages, determining device locations, predicting device movements, generating and refining publisher perimeters, and generating intelligent alert messages.

In this emergency vehicle example, identification information associated with a user device may be stored in a database hosted on a cloud server and subscribed to a specific geographical publisher region. The user software is initially off and may be enabled when the phone is turned on, when the application is opened, or when a specific setting in the application is toggled. Once enabled, the user software is initially set in a passive, low-frequency (PLF) scanning and transmitting mode. The user transmits identity and location data to the cloud-based software continuously at a low frequency. The cloud-based software then determines whether to generate a single point location or a perimeter around the publisher device based on various parameters including the user device's speed.

Identification information associated with a publishing device is also stored in the database and subscribed to a particular publisher region. The publisher software is also initially off and may be enabled when the publishing device is turned on, when the publisher application is opened, or when a specific setting in the application is toggled. When enabled, the software is initially in a silent mode. The emergency responder can then activate a broadcast mode, which actively broadcasts the location of the publisher device to the cloud-based software system. The cloud-based software then determines whether to generate a single point location or a perimeter around the publisher device based on various parameters including the publisher device's speed.

The cloud-based software continuously checks the location of the user device to determine whether it is in a publisher region it is subscribed to. Once the user device enters a publisher region it is subscribed to, the user application switches to an active, low-frequency (ALF) scanning and transmitting mode to begin actively checking for potential overlaps in location with the emergency responder.

When the cloud-based software determines that the user device (1) has entered a publisher region it is subscribed to and (2) there is at least one publisher device in an active mode in that publisher region, the user application begins active, high-frequency (AHF) scanning and transmitting of data. The user data is sent as quickly as possible to a queueing server, which uses a high-rate throughput messaging service to communicate with the cloud-based software.

The cloud-based software then checks for overlaps between the user device location data and the point or perimeter established around the publisher device. The cloud-based software also continuously predicts the future locations of the user and/or the publisher based on current and historical location data, speed data, and other data, and intelligently generates new points or perimeters for the user device and publisher device.

Once the cloud-based software determines that the point or perimeter of the user device overlaps the point or perimeter of the publisher device, an alert is pushed to the user device that disables all audio and displays an audio, visual, and/or haptic alert informing the user of an approaching emergency vehicle. The warning may include information about the estimated time of arrival of the emergency vehicle, location, direction, speed, or other information. Once the cloud-based software determines that the user device's location no longer overlaps the point or perimeter established around the publisher device, the alert is terminated. Furthermore, upon a particular triggering event, such as the user device location being a certain distance away from the publisher device's location, the user device location arriving at a pre-determined destination, and/or some other condition, the cloud-based software will cause the user software to exit AHF mode. Additionally, if the publisher device exits broadcasting mode while the user device is within its perimeter, the user device will also terminate the alert and exit AHF mode.

The software and system may be used for non-emergency purposes as well. Other applications include transportation logistics and tracking, coordination with autonomous vehicles and equipment, factory logistics and safety, social coordination, and other environments where high-speed location information is needed to warn or alert users that they are approaching another user or location of interest or concern. Accordingly, the invention may be described in more detail as follows:

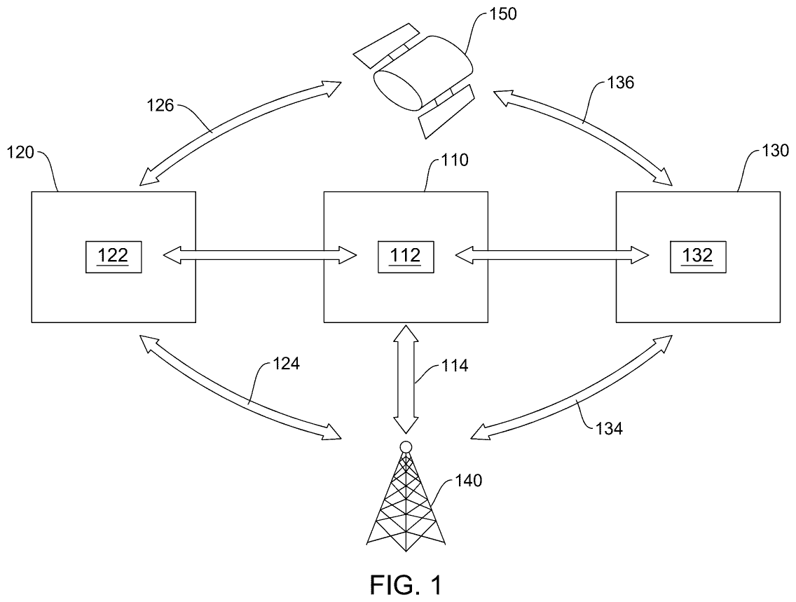

FIG. 1 illustrates the system of the present invention within the context of a typical communications network. The system 100 comprises a hub server 110, a user device 120, and a publisher device 130 in communication with a communication infrastructure for relaying data, such as a cellular tower 140. However, the communications infrastructure may be any known communications structure, including communications satellites. In such embodiments, user device 120 and/or publisher device 130 may be a satellite phone. The user device 120 and publisher device 130 may also be in communication with other communication infrastructure capable of determining location, such as Global Positioning System (GPS) satellites 150. The user device 120 sends and receives user location data 126 to and from the GPS satellites 150, while the publisher device 130 sends and receives publisher location data 136 to and from the GPS satellites 150. A hub application 112 is hosted on the hub server 110, which in preferred embodiments is located on the cloud, though other configurations such as hosting on dedicated physical servers operated by an entity such as a municipality are within the scope of the invention. The hub server 110 sends and receives communications data 114 to and from the cellular tower 140 to communicate with the user device 120 and publisher device 130. The user device 120 sends and receives communications data 124 to and from the cellular tower 140. The publisher device 130 sends and receives communications data 134 to and from the cellular tower 140. A user application 122 is installed on a user device 120, and a publisher application 132 is installed on a publisher device 130. The user application 122 sends and receives user application data 128 to and from the hub application 112 via the communication data 124 and publisher application 132 sends and receives publisher application data 138 to and from the hub application 112 via the communications data 134.

The user device 120 may be any electronic device capable of sending and receiving data wirelessly to and from other devices and networks and capable of providing alerts or notifications in an audio, visual, or haptic format. In some embodiments, the user device 120 is a smart phone. In other embodiments, the user device is a tablet computer. User location data 126 may be generated by the user device 120 through any known method, such as a module or external device that is capable of transmitting and receiving cellular or other wireless communications to and from communications infrastructure in a communications network, such as cellular towers 140 or communications satellites 150.

The publisher device 130 may be any electronic device capable of sending and receiving data wirelessly to and from other devices and networks. In some embodiments, the publisher device 130 is a smart phone. In other embodiments, the publisher device 130 is a tablet computer. In still further embodiments, the publisher device 130 is a standalone special-purpose device.

In at least one embodiment, the hub server 110 receives data from the hub application 112, the user application 122, and the publisher application 132 including publisher location data 136, user location data 126, user application data 128 that includes device identification data 160 and user application settings data 162, and publisher application settings data 164. The hub application 112 utilizes an algorithm 170 to calculate a publisher perimeter 172 encompassing an area around the publishing device 130, utilizes user location data 126 to calculate user motion vectors 174, utilizes publisher location data 136 to calculate publisher motion vectors 176, determines whether the current user location data 126 overlaps any point within the publisher perimeter 172; predicts the future user location data 127 of the user device 120; predicts the future publisher location data 137 of the publisher device 130; determines whether the predicted future user location data 127 matches with actual current user location data 126 and whether the predicted future publisher location data 137 matches with actual current publisher location data 136; updates the size and or location of the publisher perimeter 172 based on matching between current location data 126, 136 and predicted location data 127, 137; and causes an alert signal 181 to be triggered and sent to the user application 122 when the user location data 126 overlaps any point within the publisher perimeter 172.

In a preferred embodiment, the system of the present invention comprises one or more publisher regions 102. Publisher regions 102 represent the geographical boundaries within which one or more publisher devices 130 desire to broadcast their locations. In the context of an emergency vehicle alert system, the applicable publisher region 102 for an emergency responder service publisher device 130 may be the metropolitan area(s) or district(s) the emergency response service serves. This invention contemplates that the system # may include a plurality of publisher regions 102 and that the plurality of publisher regions 102 may overlap. Unique device identification information 160 associated with a publisher device 130 or user device 120 is transmitted to or created by the hub application 110 and stored in a subscriber database 116. Region identification information 103 regarding information about the plurality of publisher regions 102 is also stored in the subscriber database 116. Each user device 120 and publisher device 130 is then subscribed to one or more of the plurality of publisher regions 102. The subscriber database 116 may also be used to store other information relating to the user device 120 and publisher device 130, such as information about the device hardware and software, historical movement patterns of the user device 120 or publisher device 130, and user application 122 or publisher application 132 usage patterns and history.

The publisher device 130 is initially in a passive, silent mode 131. When in the silent mode 131, the publisher application 132 may send location data 136 and mode status to the hub application 112, but the location data 136 is not broadcast to user applications 122. The publisher device 130 must be subscribed to at least one publisher region 102 and located within that publisher region 102 before the publisher application 132 will permit the publisher device 130 to enter an active, broadcast mode 133. While in the broadcast mode 133, the publishing device 130 sends location data 136 at a high frequency to the hub application 112.

The user device 120 must be subscribed to at least one publisher region 102 before the hub application 112 will function to provide alert signals 181. In the preferred embodiment, upon opening the user application 122, the user application 122 will transmit user device identification information 160 to the hub application 122, which will check whether the user device identification information 160 is stored in the subscriber database 116. If the user device identification information 160 is not found in the subscriber database 116, then the hub application 112 will communicate to the user application 122 that the user device 120 is not registered, and the user application 122 will direct the user to register the user device 120. Once the user completes registration, the user application 122 will transmit the user device identification information 160 to the hub application 112 for storage in the subscriber database 116.

The user application 122 is initially in a passive, low-frequency scanning (PLF) mode 121. While in PLF mode 121, the user application 120 communicates with the communication network 140 to establish a communication link 128 with the hub application 112. The user application 122 transmits user identification information 160 to the hub application 112, which in turn verifies whether the user identification information 160 matches information stored in the subscriber database 116. If the user identification information 160 can be verified, the hub application 112 will transmit confirmation of authentication to the user application 122. Upon receipt of verification, the user application 122 will begin transmitting location data 126 at a first, low messaging frequency to the hub application 112.

As a user device 120 enters a publisher region 102 it is subscribed to and sends location data 126 to the hub application 112 in the PLF mode 121, the hub application 112 continuously checks the user location data 126 and determines whether the user application 122 should enter an active, low-frequency scanning (ALF) mode 123. This determination is made based on whether the current user location data 126 overlaps with any point located within the publisher region 102. While in ALF mode 123, the user application 122 utilizes higher frequency scanning and transmitting of data 124 than in the PLF mode 121.

The hub application 112 also continuously checks whether any publisher devices 130 located within the publisher region 102 are currently in a broadcast mode 133. If the hub application 122 determines both that (1) the current user location data 126 overlaps with at least one point within a publisher region 102 it is subscribed to and (2) there is at least one publisher device 130 in a broadcast mode 133 in that same publisher region 102, then the hub application 112 causes the user application 122 to enter an active, high-frequency scanning (AHF) mode 125 to communicate as quickly as possible with a queuing server 111. The queuing server 111, in turn, uses a high-rate throughput messaging service to communicate with the hub server 110. The queuing server 111 may use any high-rate throughput messaging service such as Apache Pulsar, though other similar services may be used.

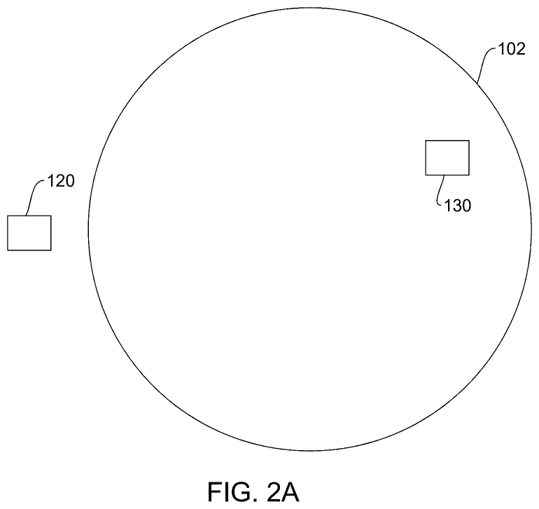

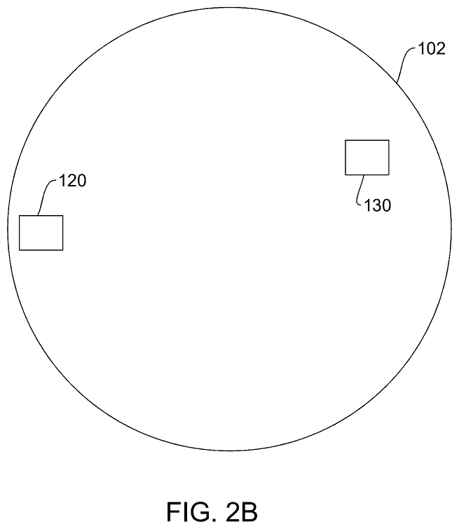

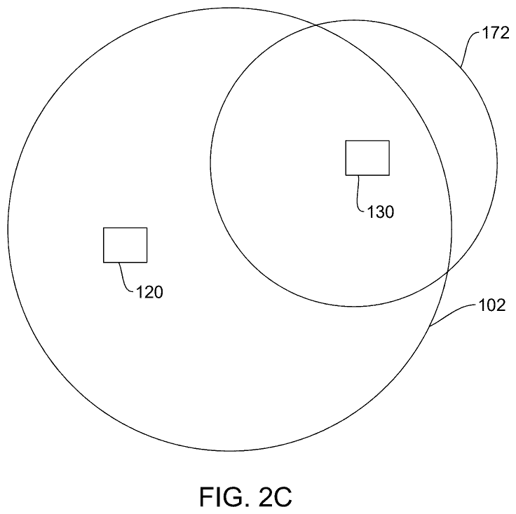

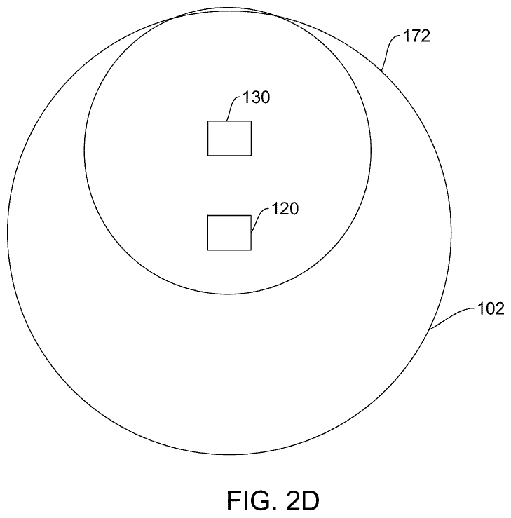

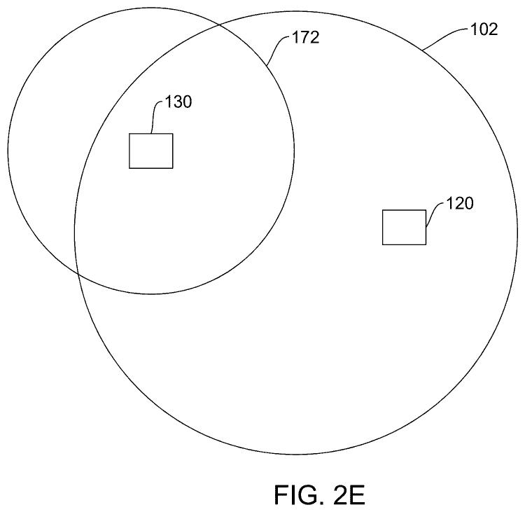

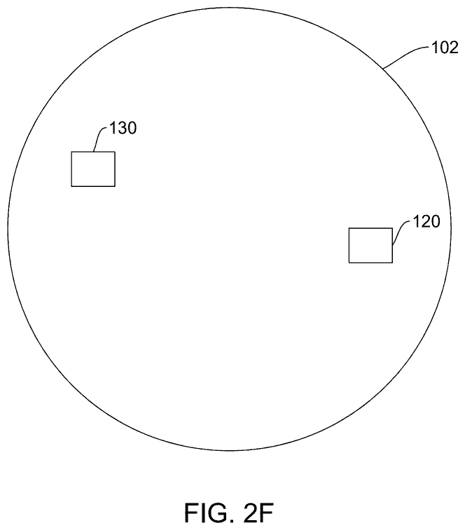

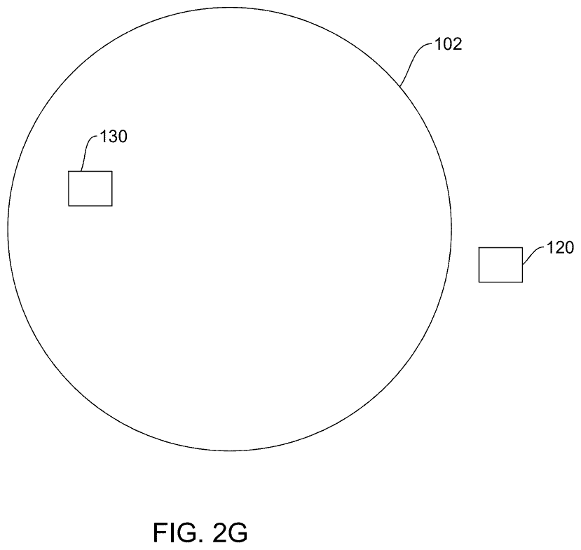

FIGS. 2A-2G are illustrative of how alerts 180 are generated and delivered to a user device 120 in accordance with system 100. As shown in FIG. 2A, a user device 120 is initially outside a publisher region 102 that the user device 120 is subscribed to, and a publisher device 130 is inside said publisher region 102 and is registered with the publisher region 102. The user device 120 is running the user application 122, and by default the user application 122 is in PLF mode 121. In some embodiments, the user application 122 must be manually activated on the user device 120. In other embodiments, the user application 122 may be automatically launched when the user device 120 is started. The publisher device 130 is also active and by default in the silent mode 131. In this configuration, the publisher application 132 sends location data 136 to the hub application 112. Because the user device 120 is not in a publisher region 102 it is subscribed to and because the publisher device 130 within said publisher region 102 is not in a broadcast mode 133, the user application 122 remains in PLF mode 121.

As shown in FIG. 2B, the user device 120 enters the publisher region 102. At this stage, when the user application 122 transmits location data 126 to the hub application 112, the hub application 112 determines that the user location 126 is within the publisher region 102 and sends a signal back to the user application 122, causing the user application 122 to enter ALF mode 123. The user device 120 then begins scanning for a signal from the hub application 112 indicating that a publishing device 130 in the publisher region 102 is in broadcast mode 133. Although the user device 120 is now in a publisher region 102 it is subscribed to, the user application 122 remains in ALF mode 123 because the publisher device 130 within said publisher region 102 not in a broadcast mode 133.

As shown in FIG. 2C, the publisher device 130 activates broadcast mode 133 and begins sending its location data 136 to the hub application 112 at a high frequency. The hub application 112 generates a publisher perimeter 172 around the location of the publishing device 130 and assigns the publisher perimeter 172 to such publishing device 130. The hub application 112 also identifies the publishing device 130 as currently in broadcast mode 133 and begins disseminating its location and status to all user devices 120 subscribed to the publisher region 102. In a preferred embodiment, the hub application 112 also sends the publisher device 130 status and location to all other publisher devices 130 that are subscribed to the publisher region 102. At this point, the hub application 112 determines that the user device 120 is located within a publisher region 102 it is subscribed to and there is at least one publisher device 130 in broadcast mode 133, and the hub application 112 causes the user device 120 to enter into AHF mode 125. In AHF mode 125, the user device 120 begins transmitting its location data 126 at a higher frequency to the hub application 112 to constantly check for overlaps with the publisher perimeter 172.

As shown in FIG. 2D, the user device 120 and publisher device 130 have moved toward each other and the user device 120 is now within the publisher perimeter 172. Once the hub application 112 determines that the location data 126 of the user device 120 is overlapping with a point located within the publisher perimeter 172, the hub application 112 generates an alert signal 181 specific to that user device 120. Once the user device 120 receives the alert signal 181, the user application 122 will provide an alert 180 to the user.

As shown in FIG. 2E, the user device 120 and publisher device 130 have continued to move apart to the extent that the user device 120 is no longer located within the publisher perimeter 172. Once the hub application 112 determines that the user location data 126 is no longer overlapping with a point located within the publisher perimeter 172, the hub application 112 generates an exit signal 191 specific to that user device 120. Once the user application 122 receives the exit signal 191, the user application 122 will provide an exit alert 190 to the user.

As shown in FIG. 2F, the user device 120 and publisher device 130 have moved apart within the publisher region 102, and the publisher device 130 has switched from broadcast mode 133 to silent mode 131. At this stage, the hub application 112 determines that the publisher device 130 is no longer in a broadcast mode 133 and sends a signal to the user application 122 causing the user device 120 to switch from AHF mode 125 to ALF mode 123.

As shown in FIG. 2G, the user device 120 has now moved outside of the publisher region 102 it is subscribed to. At this stage, the hub application 112 determines that the user device 120 is no longer within the publisher region 102 and sends a signal to the user application 122 causing the user device 120 to switch from ALF mode 123 to PLF mode 121.

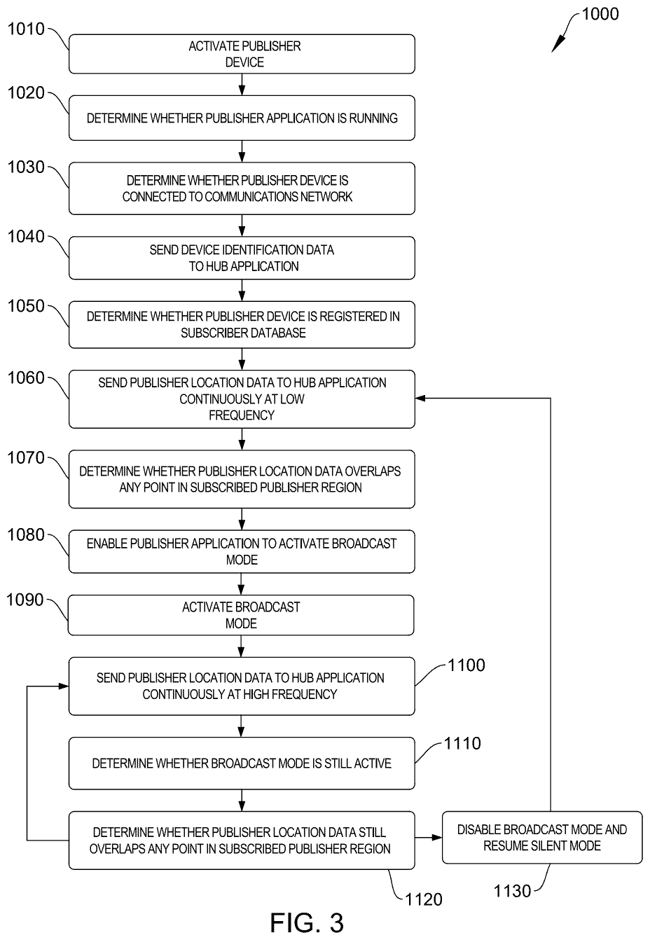

FIG. 3 is a flowchart illustrating the steps from the publisher device 130 perspective of the embodiment shown in FIGS. 2A-2G. The publisher process 1000 begins at step 1010 when the publishing device 130 is activated. At step 1020 the publishing device 130 checks whether the publisher application 132 is running. If not, the publishing device 130 continues to check for initiation of the publisher application 132. If the publisher application 132 is running, the process moves to step 1030 and checks whether the publisher device 130 is connected to a communications network 140. If not, the publisher application 132 directs the publisher to connect the publisher device 130 to a communications network 140 and continues to check for connection. If the publishing device 130 is connected to a communications network 140, the process moves to step 1040 and sends device identification data 160 to the hub application 132. At step 1050, the hub application 132 checks whether the device identification data 160 is registered in the subscriber database 116. If not, the hub application 132 directs the publisher to register the publisher device 130 and continues to check for registered device identification data 160. If the hub application 132 determines that the publishing device 130 is registered, the process moves to step 1060 and the publisher application 132 sends publisher location data 136 from the publisher device 130 to the hub application 112 at a low frequency. This corresponds to the silent mode 131 referred to above. At step 1070, the hub application 112 checks the publisher location data 136 to determine whether the publisher location data 136 overlaps with any point within any publisher region 102 that the publishing device 130 is subscribed to. If not, the hub application 112 continues to check for overlaps between the publisher location data 136 and a publisher region 102. If the hub application 132 determines that the publisher location data 136 is within a publisher region 102 that the publisher device 130 is subscribed to, the process moves to step 1080 and the hub application 112 sends a signal to the publisher application 132 enabling it to activate broadcast mode 133. At step 1090, the publisher has activated broadcast mode 133. At step 1100, the publisher application 132 begins sending current publishing location data 136 to the hub application 132 at a high frequency. At step 1110, the hub application 112 continuously checks whether the publisher application 132 is in broadcast mode 133 as long as the publisher device 130 remains in the publishing region 102, and the publisher application 132 continues to broadcast current publisher location data 136 at a high frequency to the hub application 112. At step 1120, the hub application 112 determines whether the publisher device 130 is outside of all publisher regions 102 it is subscribed to. If it is, the process returns to step 1100 to continue sending publisher location data 136 at a high rate. If the publisher location data 136 no longer overlaps the publisher region 102, the process 1000 proceeds to step 1130 wherein the broadcast mode 133 is disabled and the publisher device 130 resumes silent mode 131. At this stage, the process 1000 returns to step 1060 to continue sending publisher location data 136 at a lower rate. Note that the process 1000 will also fail at any point if the connection to the communication network 140 is terminated, or the publisher device 130 is powered off.

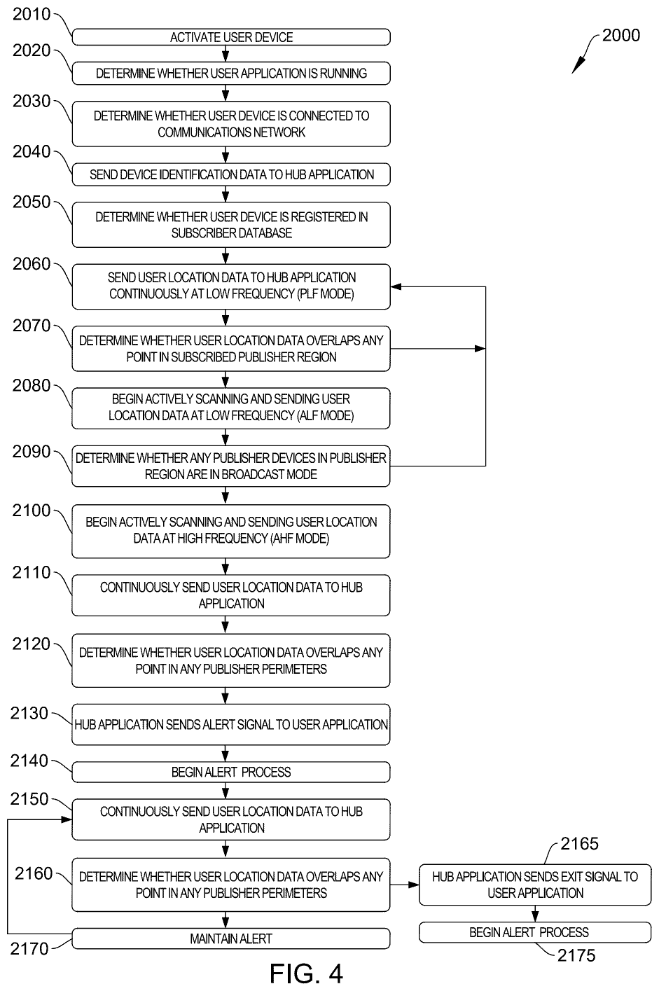

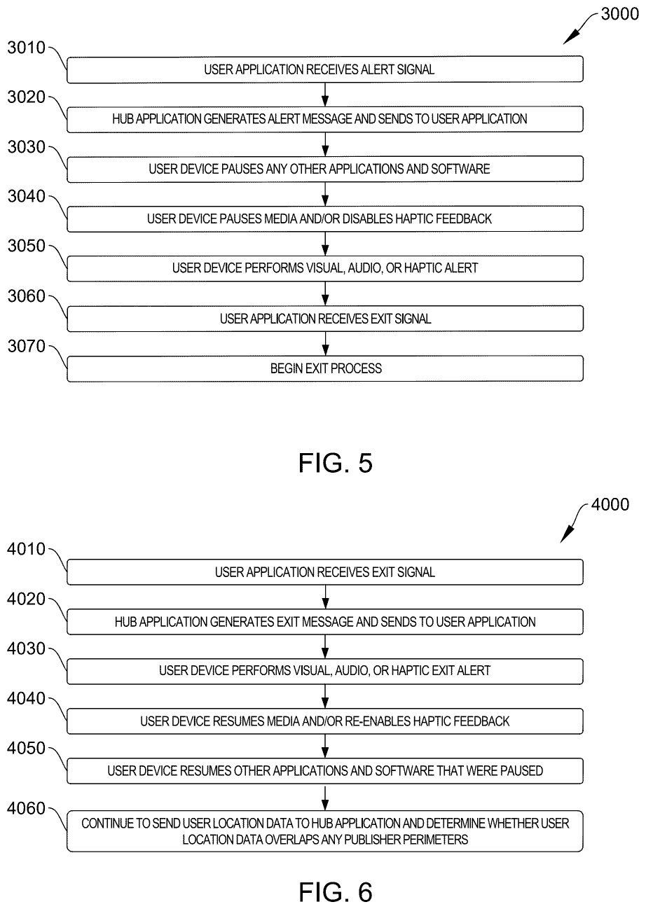

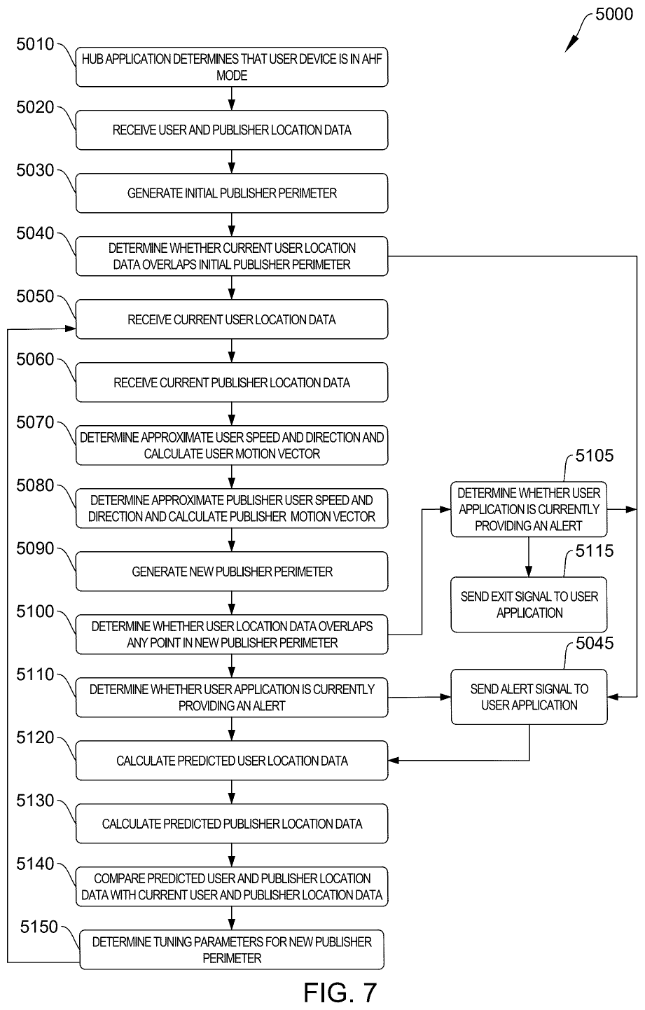

FIG. 4 is a flowchart illustrating the procedural steps from the user device 120 perspective of the embodiment shown in FIGS. 2A-2G. The user process 2000 begins at step 2010 when the user device 120 is activated. At step 2020 the user device 120 checks whether the user application 122 is running. If not, the user device 120 continues to check for initiation of the user application 122. If the user application 122 is running, the process moves to step 2030 where the user device 120 checks whether it is connected to a communications network 140. If not, the user application 122 directs the user to connect to a communications network 140 and continues to check for connection. If the user device 120 is connected to a communications network 140, the process moves to step 2040 and sends device identification data 160 to the hub application 112. At step 2050 the hub application 112 checks whether the device identification data 160 is registered in the subscriber database 116. If not, the hub application 112 directs the user to register the user device 120 and continues to check for registered device identification data 160. If the hub application 112 determines that the user device 120 is registered, the process moves to step 2060 and the user application 122 sends user location data 126 from the user device 120 to the hub application 112 at a low frequency. This corresponds to the PLF mode 121 described above. At step 2070 the hub application 112 checks the user location data 126 to determine whether the user location data 126 overlaps with any point within any publisher region 102 that the user device 120 is subscribed to. If not, the process 2000 returns to step 2060 and the hub application 112 continues to check for overlaps between the user location data 126 and a publisher region 102. If the hub application 112 determines that the user location data 126 is within a publisher region 102 that the user device 120 is subscribed to, the process moves to step 2080 the hub application 112 sends a signal to the user application 120 causing it to enter ALF mode 125. At step 2090 the hub application 112 checks whether any publishing devices 130 within the publisher region 102 are in a broadcast mode 133. If the hub application 112 determines that these conditions are not met, the hub application 112 will return to step 2060 and continue to send user location data 126 to the hub application 112 to determine whether the user location data 126 overlaps with the publisher region 102 and whether any publishing devices 130 are in broadcast mode 133. Once the hub application 112 determines that the user device location 120 is within the publisher region 102 and also determines that a publishing device 130 is in broadcast mode 133 in the publisher region 102, the process moves to step 2100 and the hub application 112 sends a signal to the user application 122 causing it to enter AHF mode 125. At step 2110, the user application 122 begins sending current user location data 126 to the hub application 112 at a high frequency. At this time, the hub application 112 has generated a publisher perimeter 172 around the approximate location of the publisher device 130 as part of process 5000, as shown in more detail in FIG. 7. At step 2120 the hub application 112 continuously checks whether the current user location data 126 overlaps any point within the publisher perimeter 172. Once the hub application 112 determines that the current user location data 126 overlaps at least one point within the publisher perimeter 172, the process moves to step 2130 and the hub application 112 generates and sends an alert signal 181 to the user application 122. At step 2140, the user application 122 initiates the alert procedure shown in FIG. 5. At step 2150, the user application 122 continues sending current user location data 126 to the hub application 112 at a high frequency. At step 2160, the hub application 112 continues checking for overlaps between current user location data 126 and the publisher perimeter 172. If the current user location data 126 and the publisher perimeter 172 continue to overlap, the process moves to step 2170 to maintain the alert, then returns to step 2150 to continue sending new user location data 126 and checking for overlaps. Once the hub application 112 determines that the current user location data 126 no longer overlaps any point within the publisher perimeter 172, the process moves to step 2165 and the hub application 112 sends an exit signal 191 to the user application 122. The process then moves to step 2175 wherein user application 122 initiates the exit procedure shown in FIG. 6.

At this stage, the process 2000 may return to step 2110 such that the user application 122 continues to send current user location data 126 to the hub application 112, and the hub application 112 continues to check for potential overlaps with any publisher perimeters 172 as long as the conditions are met. The process 2000 may continue to loop back to steps 2060, 2110, or 2150 as the case may be for as long as any publisher devices 130 are in broadcast mode 133 in the publisher region 102 and the user device 120 is in the publisher region 102. Once the hub application 112 determines that no publisher devices 130 are in broadcast mode 133 in the publisher region 102 or that the user device 120 is no longer in the publisher region 102, the hub application 112 will send a signal to the user application 122 causing it to terminate AHF mode 125 and resume ALF mode 123. Once the hub application 112 determines that the current user location data 126 no longer overlaps any point in the publisher region 102, the hub application 112 will send a signal to the user application 122 causing it to terminate ALF mode 123 and resume PLF mode 131.

FIG. 5 shows the procedural steps once the user application 122 receives an alert signal 181 from the hub application 112 in the embodiment shown in FIGS. 2A-2G. The alert process 3000 begins at step 3010 once the user application 122 receives the alert signal 181. At step 3020, the hub application 112 generates an alert message 182 that is specific that the user device 120 with respect to the publisher device 130 and sends it to the user application 122. In multiple-user environments, each user device 120 may receive a different alert message 182 with respect to the same publisher device 130. In multiple-publisher environments, the user device 120 may receive a different alert message 182 with respect to the same publisher device 130. At step 3030, the user application 122 causes the user device 120 to pause any other applications or software 183 running on the user device 120 (other than applications and software necessary to support the functioning of the user device 120 and the user application 122 as described herein). At step 3040, the user application 122 causes the user device 120 to pause any visual media 184 playing on the user device 120, pause any audio media 186 playing on the user device 120, and disable any other software or application 183 from providing haptic feedback 188 on the user device 120. At step 3050, the user device 120 performs one or more of an visual alert 185, audio alert 187, and a haptic alert 189. At step 3060, the user application 122 checks whether an exit signal 191 has been received. If not, the user application 122 maintains the pausing of applications 183 and media 184, 186, 188 and continues to check for an exit signal 191. Once an exit signal 191 is received, the process moves to step 3070 and the user application 122 initiates the exit process 4000 described in FIG. 6.

FIG. 6 shows the procedural steps once the user application 122 receives an exit signal 191 from the hub application 112 in the embodiment shown in FIGS. 2A-2G. The exit process 4000 begins at step 4010 once the user application 122 receives an exit signal 191 from the hub application 112. At step 4020 the hub application 112 generates an exit message 192 that is specific that the user device 120 with respect to the publisher device 130 and sends it to the user application 122. In multiple-user environments, each user device 120 may receive a different exit message 192 with respect to the same publisher device 130. In multiple-publisher environments, the user device 120 may receive a different exit message 192 with respect to each publisher device 130. However, the hub application 112 will not generate an exit signal 191 to a user application 122 until it determines that the current user location data 126 is not located within any publisher perimeter 172; consequently if a user device 120 is located within two different publisher perimeters 172 and exits one of the publisher perimeters 172, the hub application 112 will not generate an exit signal 191 until the user device 120 also exits that other publisher perimeter 172. Once the user application 122 receives the exit message 192, the process moves to step 4030 and the user application 122 causes the user device 120 to perform one or more of an visual exit alert 195, audio exit alert 197, and a haptic exit alert 199 on the user device 120. The process then moves to step 4040 and the hub application 122 causes the user device 120 to resume any other applications or software 183 that were previously paused during the alert 180. At step 4050, the user application 122 causes the user device 120 to resume any visual media 184 that was previously paused during the alert 180, resume any audio media 186 that was previously paused during the alert 180, re-enable any other software or application 183 that were previously disabled from providing haptic feedback 188 on the user device 120 during the alert 180. At step 4060, the exit process 4000 is completed and the system 100 continues to check for overlaps between the user location data 126 and any publisher perimeters 172.

FIG. 7 shows an example of the procedure for generating, updating, and checking for overlaps of the publisher perimeter 172 in accordance with the embodiments shown in FIGS. 2A-2G. Prior to the initiation of the publisher perimeter process 5000, the hub application 112 carries out the steps described in FIG. 4 until the point that the user device 120 enters AHF mode 125. At step 5010, the hub application 112 determines that the user device 120 is in AHF mode 125. At step 5020, the hub application 112 receives user location data 126 and publisher location data 136. At step 5030, the hub application 112 generates an initial publisher perimeter 172 using current user location data 126 and current publisher location data 136. In this embodiment, the publisher perimeter 172 is defined as a circular area having a predetermined radius 171 and centered on a point corresponding to the current publisher location data 136. The predetermined radius 171 may be determined on a number of factors. In a preferred embodiment, the predetermined radius 171 is selected based on the distance between the current user location data 126 and the current publisher location data 136 such that a user would have sufficient time to react to an alert 180 generated by the user application 122 to safely avoid a collision with a publisher. In other embodiments, however, the predetermined radius 171 may factor in historical user location data 173, historical publisher location data 175, user motion vectors 174, publisher motion vectors 176, data regarding the density and flow rate of local traffic, data regarding the routes traveled by the user device 120 and publisher device 130, user application settings 162, and publisher application settings 164. Once the initial publisher perimeter 172 is generated, the process moves to step 5040 and the hub application 112 checks whether the current user location data 126 overlaps any point within the initial publisher perimeter 172. If an overlap is detected, the process moves directly to step 5045 and the hub application 112 sends an alert signal 181 to the user application 122 to begin the alert procedure described in FIG. 5. If no overlap is detected, the process moves to step 5050 and the hub application 112 begins the process of repeatedly checking for overlaps and updating the publisher perimeter 172. At step 5050 the hub application 112 receives updated current user location data 126 from the user application 122. At step 5060 the hub application 112 receives updated current publisher location data 136 from the publisher application 130. At step 5070, the hub application 112 then determines the approximate current user speed 166 and direction 167 using current 126 and historical user location data 173 to calculate a user motion vector 174. At step 5080 the hub application 112 determines the approximate current publisher speed 168 and direction 169 using current 136 and historical publisher location data 175 to calculate a publisher motion vector 176. At step 5090, the hub application 112 uses current user location data 126, current publisher location data 136, the user motion vector 174, the publisher motion vector 176, and any tuning parameters 179 to generate a new publisher perimeter 172. The new publisher perimeter 172 is still circular in shape and will have a new radius 178 and will be centered on a point corresponding to the current publisher location data 136. The new radius 178 will be calculated to ensure that a user would have sufficient time to react to an alert 180 generated by the user application 122 to safely avoid a collision with a publisher. In some circumstances, the new radius 178 will be larger than the initial radius 171. In other circumstances, the new radius 178 may be smaller than the initial radius 171. In other embodiments, the new publisher perimeter 172 may be centered on a point that does not correspond to the current publisher location data 136, such as a point located between the current user location data 126 and current publisher location data 136 if the motion vectors 174, 176 are aligned in the same or opposite directions, or another point not located between the current user location data 126 and current publisher location data 136 if the motion vectors 174, 176 point in directions other than the same or opposite directions. At step 5100, the hub application 112 checks whether the current user location data 126 overlaps any point within the new publisher perimeter 172. If at step 5100 the hub application 112 determines that there is no overlap, then the process proceeds to step 5105 to determine whether the user application 122 is currently providing an alert. If the user application 122 is currently providing an alert 180, then this indicates that the user device 120 is no longer in a publisher perimeter 172, the process moves to step 5115 and the hub application 112 will send an exit signal 191 to the user application 122 to end process 5000. If at step 5100 the hub application 112 determines that an overlap occurred, or if at step 5105 the hub application determines that the user application 122 is not currently providing an alert 180, the process moves to step 5045 and sends an alert signal 181 to the user application 122.

In this embodiment, the hub application 112 also verifies the accuracy of its predictive algorithms 170. Thus, after sending an alert signal 181 in step 5045 or after determining that an alert 180 is already occurring, the process 5000 will move to step 5120, wherein the hub application 112 will generate a predicted user location data 127 based on the user motion vector 174, historical user location data 173, and the scanning frequency of the AHF mode 125. At step 5130, the hub application 112 will generate a predicted publisher location data 137 based on the publisher motion vector 176, historical publisher location data 175, and the messaging frequency of the broadcast mode 133. At step 5140, the hub application 112 compares current user location data 126 with predicted user location data 127 and compares current publisher location data 136 with predicted publisher location data 137. At step 5150, based on the differences between predicted locations 127, 137 and actual current locations 126, 136, the hub application 112 will determine a set of tuning parameters 179, such as whether to increase or decrease scanning frequency, increase or decrease messaging frequency, or increase or decrease the new radius 178 when a new publisher perimeter 172 is established in the next iteration of the process 5000. Once step 5150 is completed, the process returns to step 5050 wherein the hub application 112 receives updated current user location data 126. The process 5000 will continue to loop, receiving location data 126, 136, generating new publisher perimeters 172, and checking for overlaps until step 5115 occurs.

In some embodiments, the size and location of the publisher perimeter 6172 are dynamic and predictive. In determining the appropriate radius 6171 and center 6173 of the publisher perimeter 6172, the hub application 6112 takes into consideration factors such as the publishing device's 6130 current speed 6134, location 6136, and trajectory 6135, as well as historical location data 6137 and messaging data such as timestamps 6138 of messages. In some embodiments, the publishing device's 6130 current speed 6134 and trajectory 6135 may be calculated based on historical location data 6137 and data messaging timestamps 6138. In other embodiments, one or more of the publishing device's 6130 speed 6134 and trajectory 6135 may be provided directly by sensors 6139 or other equipment installed in the publishing device 6130 or another separate device. As the speed 6134 of the publishing device 6130 increases, the radius 6171 of the publisher perimeter 6172 also increases to provide an earlier warning to a user device 6120 than would have been provided for a smaller publisher perimeter 6172 at a lower speed 6134. In some embodiments, the hub application 6112 also takes into account one or more of the user device's 6120 current speed 6124 and trajectory 6125 when determining the radius 6171 and center 6173 of the publisher perimeter 6172. In such embodiments, the user device's 6120 current speed 6124 and trajectory 6125 may be calculated based on historical location data 127 and data messaging timestamps 6128. In other embodiments, one or more of the user device's 6120 speed 6124 and trajectory 6125 may be provided directly by sensors 6129 or other equipment installed in the user device 6130 or another separate device. As can be appreciated, if the user device 6120 and publishing device 6130 are traveling in opposite directions toward each other, their relative speeds 6124, 6134 are additive and the publisher perimeter 6172 will be increased. Conversely, when the user device 6120 and publishing device 6130 are traveling in the same direction, their relative speeds 6124, 134 are subtractive, and the radius 6171 of the publisher perimeter 6172 will be decreased. The hub application 6112 is provided with a predetermined threshold distance 6174 at which an alert 180 is deemed to give a user sufficient time to react to the alert 6180 and change the speed 6124 or trajectory 6125 of the user device 6120 in response to the alert 6180 in a safe manner, given the relative speeds 6124, 6134 of the user device 6120 and the publishing device 6130. In other embodiments, the center 6173 of the publisher perimeter 6172 may be shifted rather than or in addition to changing the radius 6171. In such embodiments, when it is desired to increase the sensitivity of the alert system, the algorithm 6170 will shift the center 6173 of the publisher perimeter 6172 toward the location 6126 of the user device 6120. Conversely, when it is desired to decrease the sensitivity of the alert system, the algorithm 6170 will shift the center 6173 of the publisher perimeter 6172 away from the location 6126 of the user device 6120.

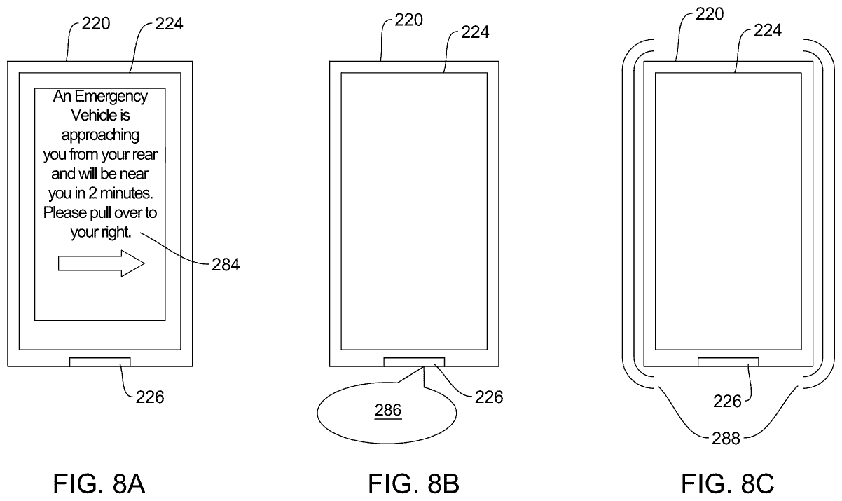

FIGS. 8A-8C show how an alert 280 may be provided on a user device 220 in one embodiment of the invention. The alert 220 comprises an alert message 282 in the form of one or more of a visual alert 285, an audio alert 287, and a haptic alert 289. In a preferred embodiment, the alert message 280 will contain additional information about the relationship between the user device 220 and publishing device 230 and/or instructions. In such embodiments, the alert message 282 contains information including one or more of: (1) an identification of the type of entity the publishing device 230 (e.g., an emergency response vehicle, construction crew, tow truck, police vehicles, etc.); (2) the direction of the publishing device 230 relative to the user device 220; (3) an estimated time of arrival; and (4) instructions or recommendations to the user device 220 to reduce or avoid the risk of collision. For example, an alert 280 generated in response to a publisher device 230 in an ambulance approaching a user device 220 may be displayed as the following textual message 284 on a screen 224 as part of a visual alert 285: “An emergency vehicle is approaching you from the rear and will be near you in 2 minutes. Please pull over to your right.” Alternatively, or in addition, the alert 280 may be an audio alert 287 played as an audio message 286 from a speaker 226 on the user device 220. Alternatively, or in addition, the alert 280 may be a haptic alert 289 that causes the user device 220 to vibrate 288 in a particular pattern. In any event, the alert 280 will cause the user application 222 to interrupt and take priority over any other applications 283 or media 281 running during the entire time the user device 220 is located within the publisher perimeter 272.

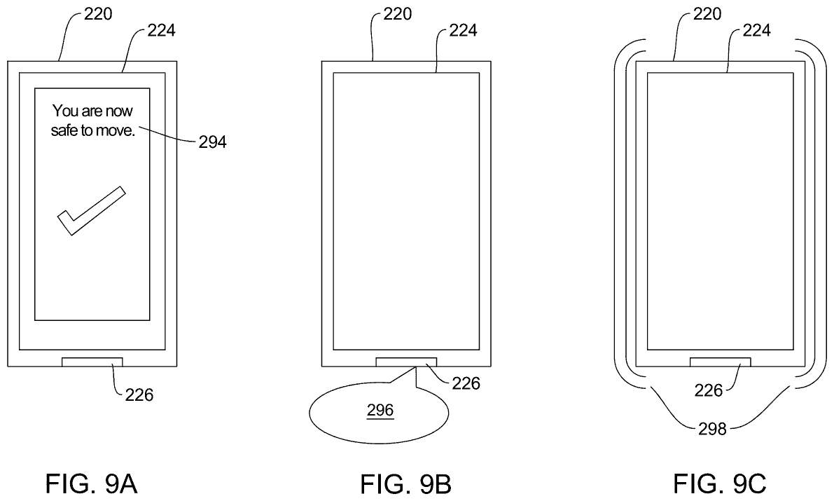

FIGS. 9A-9C show how an exit alert 290 may be provided on a user device 220 in the embodiment shown in FIGS. 8A-8C. The exit alert 290 comprises an exit message 292 in the form of one or more of a visual exit alert 295, an audio exit alert 297, and a haptic exit alert 299. In a preferred embodiment, the exit alert 295 will contain additional information about the relationship between the user device 220 and publishing device 230 and/or instructions. In such embodiments, the exit alert message 292 contains information including one or more of: (1) an indication that the hazardous situation has ended and (2) instructions or recommendations to the user device 220 to continue traveling. For example, an exit alert 290 generated in response to a user device 220 moving out of the publisher perimeter 272 of an ambulance may be displayed as the following textual exit message 284 on a screen 224 as part of a visual exit alert 285: “You are now safe to move.” Alternatively, or in addition, the exit alert 290 may be an audio exit alert 297 played as an audio exit message 296 from a speaker 226 on the user device 220. Alternatively, or in addition, the exit alert 290 may be a haptic exit alert 299 that causes the user device 220 to vibrate 298 in a particular pattern. The pattern of vibration 298 may be the same or different from the pattern of vibration 288. In any event, the exit alert 290 will cause the user application 222 to stop interrupting and resume any other applications 283 or media 281 that were previously interrupted or paused by the user application 222.

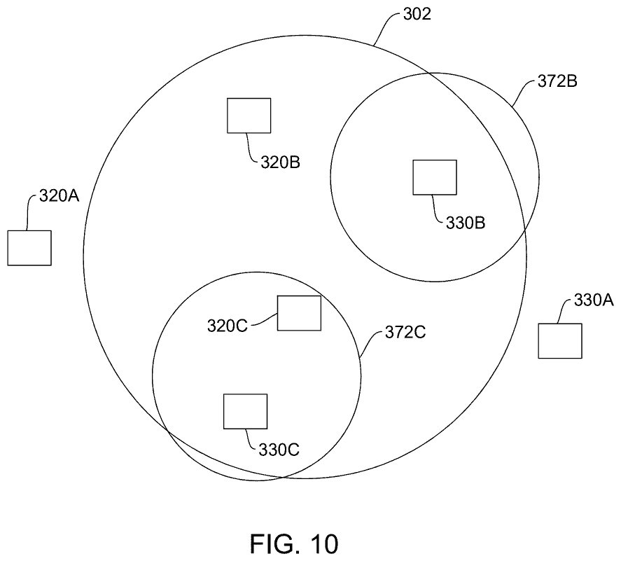

FIG. 10 illustrates the system of the present invention in a multiple user environment comprising a single publisher region 302, user devices 320A, 320B, 320C, and publisher devices 330A, 330B, 330C. All user devices 320A, 320B, 320C and publisher devices 330A, 330B, 330C are subscribed to the publisher region 302 and all user devices 320A, 320B, 320C and publisher devices 330A, 330B, 330C are running user applications 322A, 322B, 322C and publisher applications 332A, 332B, 332C, respectively. User device 320A is located outside of the publisher region 302 and is therefore in PLF mode 321A. Publisher device 330A is also located outside of the publisher region 302 and cannot enable broadcast mode 333A and is therefore in silent mode 331A. Publisher devices 330B, 330C are both located within the publisher region 302, and both have activated broadcast mode 333B, 333C. The hub application 312 has generated publisher perimeter 372B around publisher device 330B and has generated publisher perimeter 372C around publisher device 330C. The hub application 312 has determined that user device 320B is located within the publisher region 302 and has determined that at least one publisher device (both publisher device 330B and publisher device 330C) is in a broadcast mode 333B, 333C within the publisher region 302. Accordingly, the hub application 312 has caused user device 320B to enter ALF mode 323B. However, because the hub application 312 has not detected any overlaps between user device 302B's location data 326B and any point within the publisher perimeter 372B or 372C, user device 302B is not sent an alert signal 381B. However, user device 320C is within publisher perimeter 372C, and the hub application 312 sends an alert signal 381C to user device 320C specific to user device 320C which contains information relating to publisher device 330C.

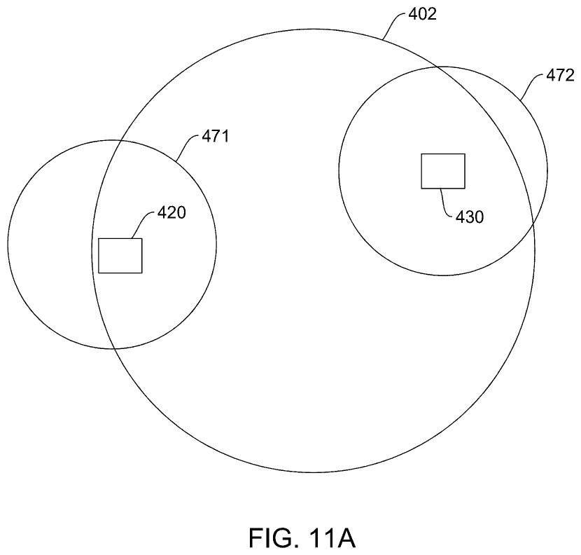

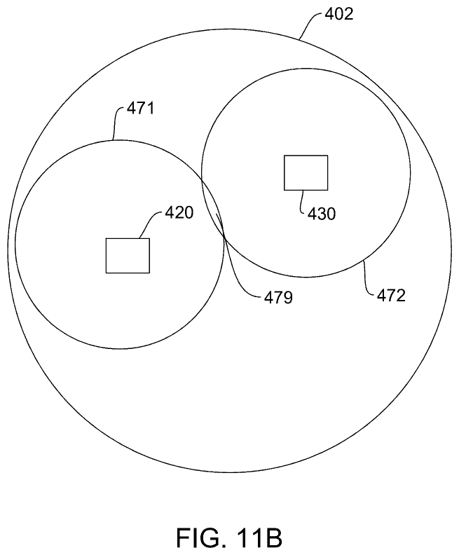

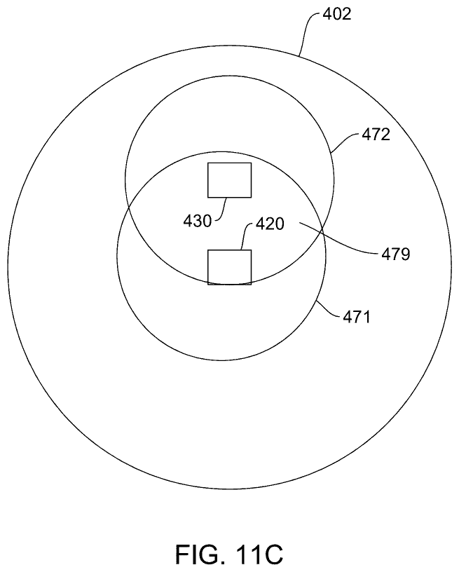

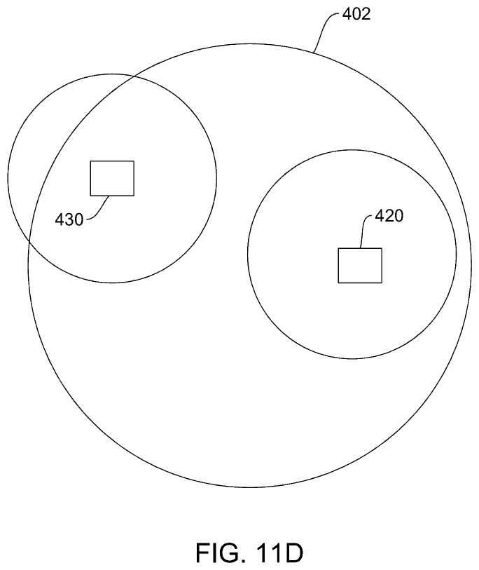

FIGS. 11A-11D illustrate an alternative embodiment wherein the hub application 412 generates a user perimeter 471 around a user device 420 in addition to the publisher perimeter 472 around the publisher device 430.

As shown in FIG. 11A, a publisher device 430 is located within a publisher region 402 that it is subscribed to and is currently in a broadcast mode 433. Consequently, the hub application 412 has generated a publisher perimeter 472 around the publisher device 430. A user device 420 is also located within the publisher region 402 and is subscribed to it. Because the publisher device 430 is in broadcast mode 433, the hub application 412 has caused the user device 420 to enter ALF mode 425. In this embodiment, however, the hub application 412 also generates a user perimeter 471 around the location of the user device 420 and assigns the user perimeter 471 to such user device 420. The hub application 412 then attempts to determine whether any point within the user perimeter 471 overlaps any point within the publisher perimeter 472 to check for overlaps.

In FIG. 11B, the user device 420 and publisher device 430 have approached each other to the extent that the user perimeter 471 is overlapping the publisher perimeter 472. The hub application 412 now detects an overlap in the overlapping region 479 between the user perimeter 471 and the publisher perimeter 472 and generates an alert signal 481 to that user device 420 initiating an alert 480.

In FIG. 11C, the user device 420 and publisher device 430 have moved closer together and the user perimeter 471 and publisher perimeter 472 are still overlapping 479. The alert 480 persists on the user device 420.

In FIG. 11D, the user device 420 and publisher device 430 have moved far enough apart that the publisher perimeter 472 is no longer overlapping the user perimeter 471. The hub application 412 now detects no overlaps 479 between the user perimeter 471 and the publisher perimeter 472 and generates an exit signal 491 to that user device 420.

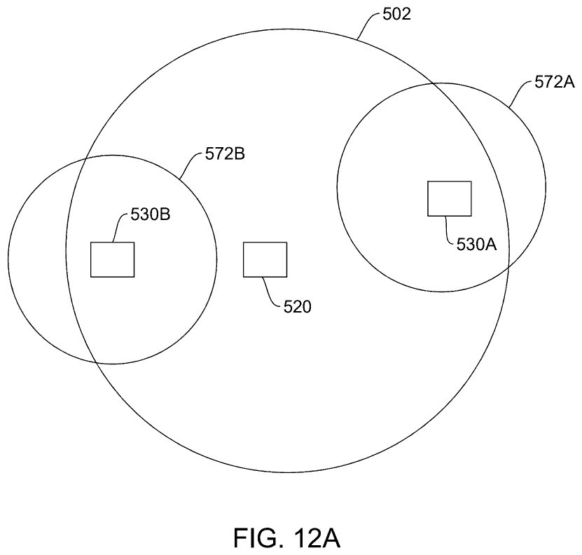

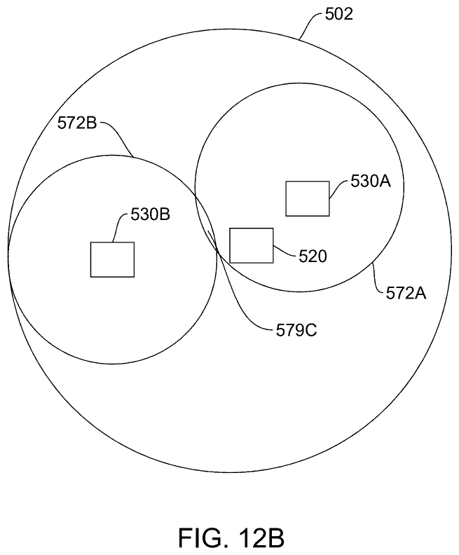

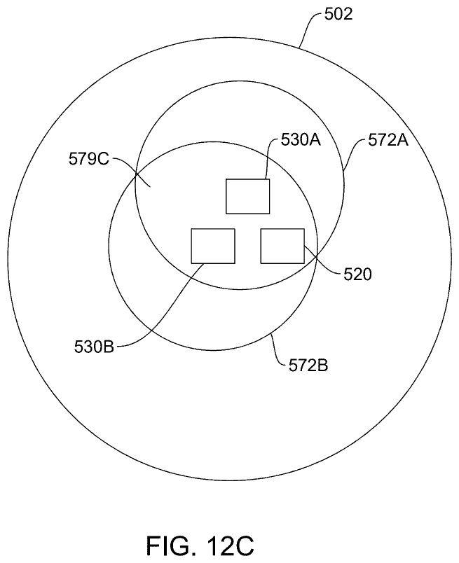

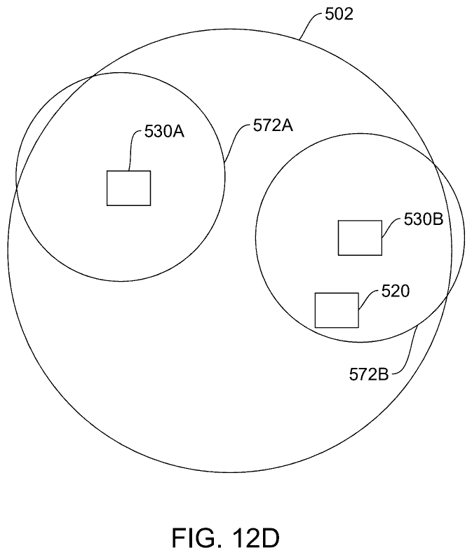

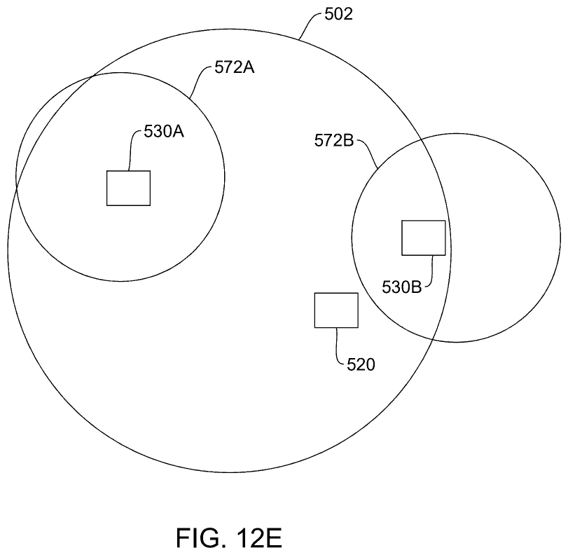

FIGS. 12A-12E illustrate an alternative embodiment of a single user device 520 in an environment involving a plurality of publisher devices 530A, 530B.

As shown in FIG. 12A publisher devices 530A, 530B are located within a publisher region 502 that they are both subscribed to. Publisher devices 530A, 530B are currently in a broadcast mode 533A, 533B. Consequently, the hub application 512 has generated a publisher perimeter 572A around publisher device 530A and has also generated a separate publisher perimeter 572B around publisher device 530B. A user device 520 is also located within the publisher region 502 and is subscribed to it. Because at least one publisher device 530A, 530B in the publisher region 502 is in broadcast mode 533A, 533B, the hub application 512 has caused the user device 520 to enter ALF mode 523. The hub application 512 then attempts to determine whether the user device location data 526 overlaps any point within publisher perimeter 572A to check for overlaps 579A. Simultaneously, the hub application 512 also attempts to determine whether the user device location data 526 overlaps any point within publisher perimeter 572B to check for overlaps 579B. Simultaneously, the hub application 512 also attempts to determine whether any point within publisher perimeter 572A overlaps any point within publisher perimeter 572B to check for overlaps 579C.

In FIG. 12B, user device 520 and publisher device 530B have both moved toward publisher device 530A to the extent that the user location data 526 now overlaps at least one point within publisher perimeter 572A, and at least one point within publisher perimeter 572B now overlaps at least one point within publisher perimeter 572A. At this point, the hub application 512 now detects an overlap in the overlapping region 579A between the publisher perimeter 572A and the user device 520 and generates an alert signal 581A to user application 522 initiating an alert 580A regarding publisher device 530A. In addition, the hub application 512 now detects an overlap in the overlapping region 579C between the publisher perimeter 572B and the publisher perimeter 572A, generates an alert signal 581C to publisher application 532B initiating an alert 580C regarding publisher device 530A, and generates an alert signal 581D to publisher application 532A initiating an alert 580D regarding publisher device 530B. Alert signals 581C, 581D may contain different message content and information from alert signal 581A and may have different functions on publisher application 532A, 532B than alert signal 581A has on user application 522.

In FIG. 12C, the user device 520 has stopped moving because the user has pulled their vehicle over in response to alert 580A. Publisher device 530A and publisher device 530B continue to approach each other to the extent that user device 520 is now located within both publisher perimeter 572A and publisher perimeter 572B. The hub application 512 now detects an overlap in the overlapping region 579B between the publisher perimeter 572B and the user device 520 and generates an alert signal 581B to the user application 522 regarding publisher device 530B. Publisher device 530B continues to provide alert 580C and publisher device 530A continues to provide alert 580D.

In FIG. 12D, publisher device 530A has moved to the extent that both the user device 520 and publisher device 530B are no longer located within publisher perimeter 572A. The hub application 512 determines that there is no longer an overlap 579C between publisher device 530A and publisher device 530B and sends an exit signal 591C to publisher application 532B initiating an exit alert 590C with respect to publisher device 530A and sends an exit signal 591D to publisher application 532A initiating an exit alert 590D with respect to publisher device 530B. The hub application 512 determines that there is no longer an overlap 579A between publisher device 530A and user device 520 and sends an exit signal 591A to the user application 522 with respect to publisher device 530A. However, because user device 520 is still located within publisher perimeter 572B, the user application 522 continues to display alert 580B and continues to pause and interrupt other applications 583 and any visual media 584, audio media 586, and/or haptic feedback 588 on user device 520.

In FIG. 12E, the user device 520 and publisher device 530B have now moved far enough apart from each other that the user location data 526 no longer overlaps a point within publisher perimeter 572B. The hub application 512 now detects no overlap between the publisher perimeter 572B and the user location data 526 and generates an exit signal 591B to user application 522.

Some embodiments may include multiple publisher regions. In such embodiments, it is possible that such publisher regions may overlap, and that a user device may be located within the boundaries of more than one publisher region. In such a scenario, the system operates essentially the same as in the embodiments of FIGS. 2A-2G, but the hub application will determine whether to send alert signals to the user device with respect to any publishing devices in all of the publisher regions.

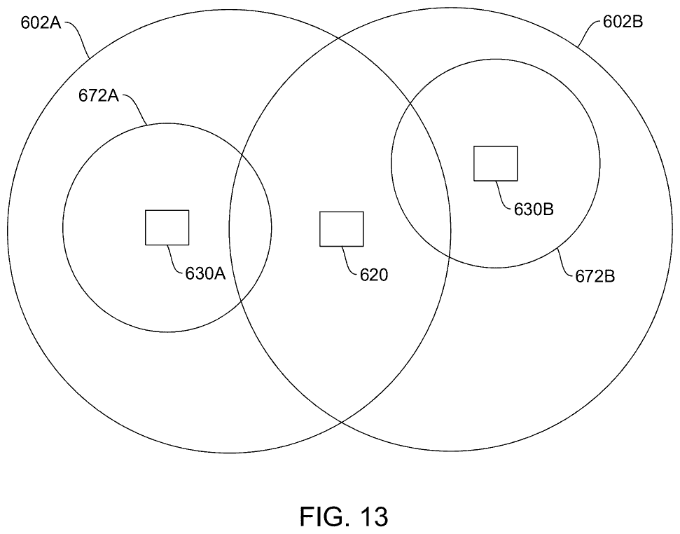

FIG. 13 illustrates an alternative embodiment of a single user device 620 in an environment involving a plurality of publisher devices 630A, 630B and a plurality of publisher regions 602A, 602B. Publisher device 630A is located within and subscribed to publisher region 602A, and publisher device 630B is located within and subscribed to publisher region 602B which is overlapping 603 publisher region 602B. User device 620 is located within the overlapping region 603 between publisher region 602A and publisher region 602B

In this example, publisher device 630A and publisher device 630B are both in broadcast mode 633A, 633B. Consequently, the hub application 612 has generated a publisher perimeter 672A around publisher device 630A and has also generated a separate publisher perimeter 672B around publisher device 630B. The hub application 612 detects that the user device 620 is located within publisher region 602A and that at least one publishing device within that publisher region 602A is in broadcast mode 633A. The hub application 612 also detects that the user device 620 is located within publisher region 602B and that at least one publishing device 630B within that publisher region 602B is in broadcast mode 633B. Accordingly, the hub application 612 will cause the user device 620 to enter AHF mode 625 and the user application 622 will scan simultaneously within publisher region 602A for potential overlaps with publisher perimeter 672A and within publisher region 602B for potential overlaps with publisher perimeter 672B. If the user location data 626 overlaps at least one point within publisher perimeter 672A, the hub application 612 will send an alert signal 681A to user device 620, and if the user location data 626 overlaps at least one point within the publisher perimeter 672B, the hub application 612 will send an alert signal 681B to the user device 620.

In some embodiments involving multiple publisher regions, the system may be modified such that the hub application will not attempt to calculate a publisher perimeter around a publishing device in a publishing mode if such publishing device is located further than a predetermined distance from the user device. By restricting resource-intensive operations only to those hazards that are nearby and likely to be encountered soon, the system will save on computational resources and the user device will conserve power, resulting in a more reliable and robust warning system.

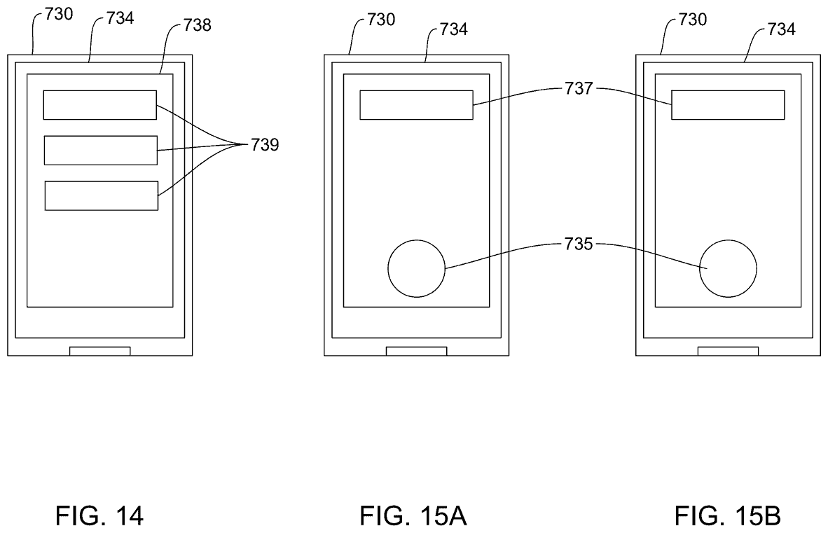

In some embodiments, the publisher device 730 is a cellular phone or tablet computer. In such embodiments, the publisher device comprises: a display screen 734, an input mechanism 746, such as a keyboard, mouse, stylus, touchscreen, or the like, enabling the publisher to interact with the publisher device 730; a switch 735 to activate a broadcast mode 733; a transmitter 742 capable of sending data to a communications network 740; a receiver 744 capable of receiving data from a communications network 740; a processor 748; and a memory 749. Publisher application 732 software is stored in the memory 749 and installed on the publisher device 730. The switch 735 may be a software feature that can be toggled in the publisher application 732. In other embodiments, the switch 735 may be a physical toggle or button disposed remotely from the publisher device 730 and in communication with the publisher device 730 via a wired or wireless connection. FIGS. 14, 15A, and 15B shows an example of a publisher device 730 showing a display screen 734 within the publisher application 732.

FIG. 14 shows an example of a settings menu 738 comprising multiple options 739. These options 739 may include, for example, settings to vary the frequency at which the publisher location data 736 is sent to the hub application 712, settings to change the entity type 705 of the publisher device 730, or settings relating to the size or shape of the publisher perimeter 772 associated with that publisher device 730. FIG. 15A shows an example of a display screen 734 where the publisher device 730 is located within a publisher region 702 and is currently in silent mode 731. The display screen 734 indicates the current mode status 737, which in FIG. 15A is currently silent mode 731, and also includes a switch 735 to activate broadcast mode 733. When the switch 735 in FIG. 15A is activated, the publisher application 732 causes the publisher device 730 to enter broadcast mode 733 and changes to the display screen 734 from the one shown in FIG. 15A to the display screen 734 shown in FIG. 15B. In FIG. 15B, the display screen 734 indicates the current mode status 737, which in FIG. 15B is currently broadcast mode 733, and also includes a switch 735 to de-activate broadcast mode 733. When the switch 735 in FIG. 15B is activated, the publisher application 732 causes the publisher device 730 to enter silent mode 731 and changes the publisher screen 734 from the one shown in FIG. 15B to publisher screen 734 as shown in FIG. 15A.

In some embodiments, the publishing device 830 may consist of a specialized device that is neither a smart phone nor a tablet computer. In some of those embodiments, the publishing device 830 is an on-board computer system and communications hardware 805 installed in a publisher vehicle 804. In still other embodiments, the components of the publishing device 830 may be embodied into one or more physically separate peripheral devices 808 distributed around and incorporated into the publisher vehicle 804.

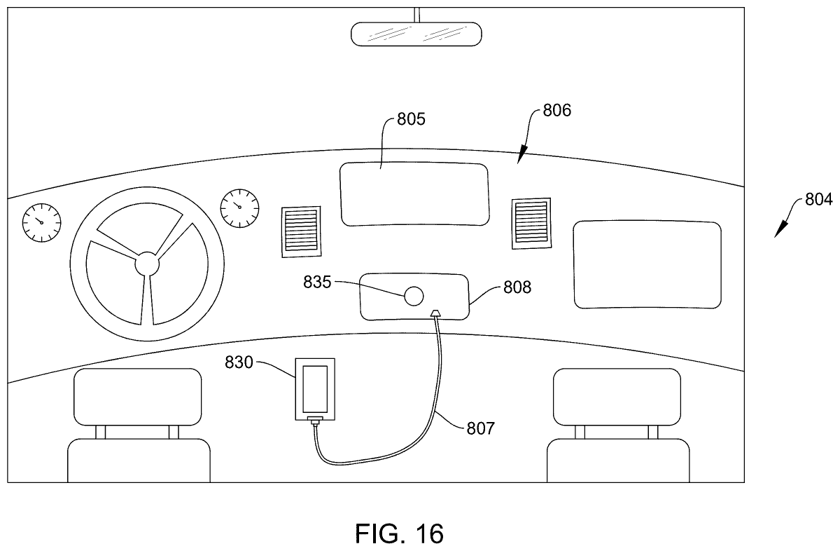

FIG. 16 illustrates an alternative embodiment wherein the switch 835 is located physically separate from the publisher device 830. The switch 835 is a physical toggle located on a peripheral device 808 mounted into the dashboard 806 of the publisher vehicle 804. The peripheral device 808 is in communication with the publisher device 830 and is capable of sending a switch signal 837 to the publisher application 832 that changes modes between silent mode 831 and broadcast mode 833. In this embodiment, the switch signal 837 may be sent via a wired data connection 807, such as a USB-C format, connected between the publisher device 830 and the peripheral device 808. In other embodiments, the switch signal 837 may be sent via a wireless data connection 809, such as Bluetooth, connected between the publisher device 830 and the peripheral device 808. In an alternative embodiment, the peripheral device 808 may send a switch signal 837 directly to the hub application 812.

In some embodiments, the alert 2180 may be displayed or performed on a peripheral alert device 2121 that is physically separate from the user device 2120. The peripheral alert device 2121 may be any device for: displaying a visual signal renderable as text, an image, and/or a series of images, playing aloud an audio signal; and/or causing vibrations. By way of non-limiting example, the peripheral alert device 2121 may be an external speaker, vehicle-mounted speaker, earphones/earbuds, an external screen, vehicle-mounted screen, augmented-reality wearable devices, vibrators as wearable devices, and vibrators installed in a vehicle, such as in the seat or steering wheel. In such embodiments, the user device 2120 may communicate with the peripheral alert device 2121 through any known method, including but not limited to, a wired connection, a WiFi connection, or a Bluetooth connection.

In some embodiments, the type of media paused by the user application 2222 will depend on the type of alert 2280. In embodiments where the alert 2280 comprises an audio alert 2287, the user application 2222 will pause any audio media 2286 playing from the user device 2220 while the user device 2220 is located within the publisher perimeter 2272. Once the user device 2270 leaves the publisher perimeter 2270, the user application 2222 will cause the user device 2220 to resume playing the paused audio media 2286. In embodiments where the alert 2280 comprises a visual alert 2285, the user application 2222 will pause any video media 2284 playing on the user device 2220 while the user device 2220 is located within the publisher perimeter 2272. Once the user device 2220 leaves the publisher perimeter 2272, the user application 2222 will cause the user device 2220 to resume playing the paused video media 2285. In embodiments where the alert 2280 comprises a haptic alert 2289, the user application 2222 will prevent any other application 2283 from generating haptic feedback 2288 on the user device 2220 while the user device 2220 is located within the publisher perimeter 2272. Once the user device 2220 exits the publisher perimeter 2272, the other applications and software 2283 will be permitted to provide haptic feedback 2288. Unlike with audio media 2286 and visual media 2284, haptic feedback 2288 is not paused and resumed but is actually disabled and re-enabled for such other applications and software 2286.

In at least one embodiment, the user device 2320 is a cellular phone or tablet computer. In such embodiments, the user device 2320 comprises: a display screen 2324, an input mechanism 2322, such as a keyboard, mouse, stylus, touchscreen, or the like, enabling the user to interact with the user device #; an alert mechanism 2321, such as a display screen 2324 (for visual alerts), speaker 2326 (for audio alerts), or vibrator 2328 (for haptic alerts); a transmitter 2323 capable of sending data to a communications network 2340; a receiver 2325 capable of receiving data from a communications network 2340; a processor 2327; and a memory 2329.

In some embodiments, the exit signal 2491 is sent to the user application 2422 upon the occurrence of some triggering event 2401 other than the hub application 2412 detecting that the user location data 2426 is no longer overlapping with a point located within a publisher perimeter 2472. Such triggering event 2401 may be that the user location data 2426 overlaps a predetermined location 2404 or a point within a predetermined area 2405. In other cases, the triggering event 2401 may be that a certain amount of time 2406 has elapsed since the user location data 2426 has changed, indicating that the user device 2420 has stopped moving altogether or that the user application 2422 has encountered an error and is no longer behaving reliably.

In some embodiments, the alert system 2500 may suggest alternate routes for a user device 2520. Such system 2500 may include a navigation system 2504 that displays a map 2505 showing the user device 2520 and the current route 2506. When the user device 2520 is in AHF mode 2525, the hub application 2512 will attempt to determine whether the publisher device 2530 is on the same route 2506 as the user device 2520 based on location information 2526, 2536 received from the user application 2520 and the publisher application 2530. If the user device 2520 and publisher device 2530 are on the same route 2506, the hub application 2512 will determine an alternative route 2507 that is different from the current route 2506 such that the predicted future user location data 2527 along the entirety of the alternative route 2507 avoids overlapping any point within any publisher perimeter 2572 along the entirety of the original route 2506 using an intelligent algorithm 2570, and provides the user application 2522 with an option to select the alternative route 2507. This embodiment may be further modified to display the approximate current locations of all publisher devices 2530 in broadcast mode 2533 within the publisher region 2502. The locations of user devices 2520 and publisher devices 2530 may be shown with icons such as pins in real time. The navigation system 2504 and map 2505 may be any navigation system and map capable of the above features, including existing products such as Google Maps or Apple Maps.

In a further modification, the hub application 2512 analyzes the movement patterns 2578 of all user devices 2520 and publisher devices 2530 within the system 2500 and determines based on historical movement patterns whether the user devices 2520 and publisher devices 2530 are appearing to get slowed down or stopped in a particular area, which would indicate the location of an emergency or other event resulting in traffic 2509. The system 2500 can provide a traffic alert 2580 as well as a suggestion 2582 to find an alternate route to avoid traffic 2509.

As it can be appreciated, the system of the present invention can be applied to other contexts besides emergency notifications regarding vehicles. Other applications include transportation logistics and tracking, coordination with autonomous vehicles and equipment, factory logistics and safety, social coordination, and other environments where high-speed location information is needed to warn or alert users that they are approaching another user or location of interest or concern.

We claim:

1. A system for generating proximity-based alerts in real-time comprising:
a computer-readable media having computer-executable instructions embodied therein that when executed by a computer causes the computer to receive a first location data from a first device and a second location data from a second device;
wherein the computer-readable media causes the computer to generate a first perimeter having a first predetermined radius using at least the second location data;
wherein the computer-readable media causes the computer to determine whether the first location data overlaps any point within the first perimeter;
wherein if the computer determines that the first location data overlaps any point within the first perimeter, the computer-readable media causes the computer to generate and send data comprising a first signal to the first device and upon receipt of such first signal the first device performs an alert;
wherein after the computer sends the first signal to the first device the computer-readable media causes the computer to receive a third location data from the first device and a fourth location data from the second device;
wherein the computer-readable media causes the computer to generate a second perimeter having a second predetermined radius using at least the fourth location data;
wherein the computer-readable media causes the computer to determine whether the third location data overlaps any point within the second perimeter; and
wherein if the computer determines that the third location data does not overlap any point within the second perimeter, the computer-readable media causes the computer to generate and send data comprising a second signal to the first device and upon receipt of such second signal the first device performs an exit alert.

2. The system according to claim 1 further comprising a region having a first boundary wherein prior to generating the first perimeter the computer-readable media causes the computer to determine whether the first location data overlaps any point within the region, wherein if the first location does not overlap any point within the region the first device transmits the first location data at a first rate to the computer, and wherein if the first location overlaps any point within the region the first device to transmit the first location data to the computer at a second rate higher than the first rate.

3. The system according to claim 2 wherein the second device is capable of transmitting second location data in a first mode and in a second mode, wherein prior to generating the first perimeter the computer-readable media causes the computer to determine whether the second device is in the second mode and whether the first device is transmitting first location data at the second rate, wherein if the second device is in the second mode and the first device is transmitting first location data at the second rate the first device transmits the first location data to the computer at a third rate higher than the second rate.

4. The system according to claim 1 wherein after the computer determines whether the first location data overlaps any point within the first perimeter the computer-readable media causes the computer to generate a motion vector corresponding to the first device and to generate a fifth location data based on at least the first location data and the motion vector, wherein the computer-readable media causes the computer to determine the differences between the fifth location data and the third location data, and wherein the computer-readable media causes the computer to generate the second perimeter using at least the fourth location data and the differences between the fifth location data and the third location data.

5. The system according to claim 1 wherein after the computer-readable media causes the computer to generate the first perimeter, the computer-readable media causes the computer to generate a third perimeter having a third predetermined radius using at least the first location data wherein the computer-readable media causes the computer to determine whether any point within the third perimeter overlaps any point within the first perimeter, wherein if the computer determines that any point within the third perimeter overlaps any point within the first perimeter, the computer-readable media causes the computer to generate and send data comprising a first signal to the first device and upon receipt of such first signal the first device performs an alert, wherein after the computer sends the first signal to the first device the computer-readable media causes the computer to receive a third location data from the first device and a fourth location data from the second device, wherein the computer-readable media causes the computer to generate a second perimeter having a second predetermined radius using at least the fourth location data and a fourth perimeter having a fourth predetermined radius using at least the third location data, and wherein if the computer determines that any point within the fourth perimeter overlaps any point within the second perimeter, the computer-readable media causes the computer to generate and send data comprising a second signal to the first device and upon receipt of such second signal the first device performs an exit alert.

6. The system according to claim 1 wherein after the computer sends the first signal to the first device, the computer-readable media causes the computer to receive a third location data from the first device and the computer-readable media causes the computer to determine whether the third location data overlaps a predetermined location or any point within a predetermined area, and wherein if the computer determines that the third location data overlaps such predetermined location or point within a predetermined area, the computer-readable media causes the computer to generate and send data comprising a second signal to the first device and upon receipt of such second signal the first device performs an exit alert.

7. The system according to claim 1 further comprising a screen, wherein the first device is configured to generate a virtual navigation map and display it on the screen, wherein the computer-readable media causes the computer to generate a current estimated location of the first device and a current estimated location of the second device and transmit the current estimated location of the first device and the current estimated location of the second device to the first device, and wherein the virtual navigation map displays a first graphic or symbol corresponding to the current estimated location of the first device and a second graphic or symbol corresponding to the current estimated location of the second device.

8. The system according to claim 1 wherein the alert or exit alert is one or more of a visual message comprising one or more of text and graphics displayable on a screen, an audio message comprising an audio signal capable of being played from a speaker, and a haptic message comprising vibrations generated by a vibration element.

9. The system according to claim 8, wherein when the alert is a visual message or audio message, the visual message or audio message contains information comprising one or more of information about the identity of the second device, information about the direction of the second device relative to the first device, information about the estimated time in which the location of the second device will be within a pre-determined distance of the location of the first device, and instructions.

10. The system according to claim 1 wherein the alert signal causes the first device to perform one or more of pausing any video media playing on the first device, pausing any audio media playing on the first device, and disabling the vibratory functions of any software applications running on the first device.

11. The system according to claim 1 wherein either or both of the first device and the second device are mobile phones, smart phones, satellite phones, or tablet computers.

12. The system according to claim 1 wherein the second device is associated with a service organization providing one or more of a law enforcement service, a firefighting service, an emergency healthcare service, a hazardous materials service, a traffic safety service, an emergency roadside assistance service, or a towing service.

13. A system for generating proximity-based alerts in real-time comprising:
a first software installed on a first device and capable of receiving data comprising a geographic location of the first device;
a second software installed on a second device and capable of receiving data comprising a geographic location of the second device;
a third software installed on a third device capable of communicating with the first software and the second software to send and receive data between the third software and first software and between the third software and the second software;
wherein one or more of the first device and the second device are moving such that the geographic location of the first device and/or the geographic location of the second device changes with time;
wherein the second software sends data comprising the instant geographic location of the second device to the third software and the third software generates a first perimeter associated with the instant geographic location of the second device and having a first predetermined radius;
wherein the first software sends data comprising the instant geographic location of the first device to the third software and the third software determines whether the instant geographic location of the first device overlaps any point within the first perimeter;
wherein the first software continuously sends new data comprising the instant geographic location of the first device associated with a first time frame to the third software and the second software continuously sends new data comprising the instant geographic location of the second device associated with the first time frame to the third software, and the third software generates a plurality of new perimeters over time, each new perimeter associated with a different instant geographic location of the second device at a given time and each new perimeter having a new radius;
wherein when the third software determines that the instant geographic location of the first device overlaps any point within the first perimeter or any new perimeter the third software generates and sends data comprising a first signal to the first software and upon receipt of such first signal the first software causes the first device to perform an alert; and
wherein after sending the first signal the third software later determines that any new instant geographic location of the first device does not overlap the new perimeter corresponding to the same given time the third software generates and sends data comprising a second signal to the first software and upon receipt of such second signal the first software causes the first device to perform an exit alert.

14. The system according to claim 13, wherein the second software is initially in a first broadcast mode wherein the second software sends data comprising the instant geographic location of the second device and data corresponding to the first broadcast mode to the third software, wherein the second software is capable of switching to a second broadcast mode wherein the second software sends data comprising the instant geographic location of the second device and data corresponding to the second broadcast mode to the third software, wherein the second broadcast mode is entered upon manual activation of a switch, and wherein the third software generates new perimeters only when the second software is in the second broadcast mode.

15. The system according to claim 14, further comprising a first geographic region, wherein the first device further comprises first device identification information, wherein the third software further comprises a database containing a plurality of device identifiers associated with the first geographic region, wherein prior to the third software generating the first perimeter, the first software sends the first device identification information to the third software, wherein the third software determines whether the first device identification information matches any device identifiers in the database, wherein if a match is determined the third software proceeds with generating the first perimeter, and wherein if a match is not determined the third software sends a third signal to the first software prompting it to register the first device identification information as a new device identifier in the database.

16. The system according to claim 15, wherein the first software is initially in a first scan mode wherein the first software sends data comprising the instant geographic location of the first device to the third software at a first rate, wherein the first software is capable of switching to a second scan mode wherein the first software sends data comprising the instant geographic location of the first device to the third software at a second rate greater than the first rate, the first software switches from the first scan mode to the second scan mode when the first device identification information matches any device identifier in the database, the user device is located within the first geographic region, and the second device is in the second broadcast mode.

17. The system according to claim 11, further comprising a first geographic region, wherein the second device further comprises second device identification information, wherein the third software further comprises a database containing a plurality of device identifiers associated with the first geographic region, wherein prior to the third software generating the first perimeter, the second software sends the second device identification information to the third software, wherein the third software determines whether the second device identification information matches any device identifiers in the database, wherein if a match is determined the third software proceeds with generating the first perimeter, and wherein if a match is not determined the third software sends a third signal to the second software prompting it to register the second device identification information as a new device identifier in the database.

18. The system according to claim 17, wherein the switch is a physical device separate from the first device and in communication with the second software.

19. The system according to claim 18, wherein the second software is prohibited from activating the second broadcast mode if the instant geographic location of the second device does not overlap any point within the first geographic region.

20. A method for generating proximity-based alerts in real-time comprising the following steps:
a. Obtaining data corresponding to a first location of a first device and data corresponding to the first location of a second device,
b. Determining whether the first location of the first device overlaps any point within a region defined by a pre-determined boundary,
c. If it is determined that an overlap did not occur in step (b), returning to step (a),
d. If it is determined that an overlap occurred in step (b), obtaining data corresponding to a broadcast mode of the second device,
e. Determining whether the second device is in the broadcast mode,
f. If it is determined that the second device is not in the broadcast mode in step (e), returning to step (a),
g. If it is determined that the second device is in the broadcast mode in step (e), generating a first perimeter having a first radius based at least on the first location of the second device,
h. Determining whether the first location of the first device overlaps any point within the first perimeter,
i. If it is determined that an overlap occurred in step (h), generating a first signal and sending it to the first device,
j. Obtaining data corresponding to a new location of the first device and data corresponding to a new location of the second device,
k. Generating a new perimeter having a new radius based on at least the new location of the second device,
l. Determining whether the new location of the first device overlaps any point within the new perimeter,
m. If it is determined that an overlap occurred in both step (h) and step (l), returning to step (j),
n. If it is determined that an overlap did not occur in step (h) but did occur in step (l), generating a first signal and sending it to the first device, and returning to step (j), and
o. If it is determined that an overlap did not occur in step (l), generating a second signal and sending it to the first device.
